(19) United States
(12) Patent Application Publication
(10) Pub. No.: US 2019/0180238 A1
(43) Pub. Date: Jun. 13, 2019

(54) OPERATION MANAGEMENT APPARATUS, OPERATION MANAGEMENT SYSTEM, AND METHOD FOR MANAGING OPERATION

(71) Applicant: KAMOMEYA Inc., Kagawa (JP)

(72) Inventor: Masato ONO, Kagawa (JP)

(73) Assignee: KAMOMEYA Inc., Kagawa (JP)

(21) Appl. No.: 16/275,279

(22) Filed: Feb. 13, 2019

Related U.S. Application Data
(63) Continuation of application No. PCT/JP2018/037008, filed on Oct. 3, 2018.

(30) Foreign Application Priority Data
Nov. 24, 2017 (JP) 2017-225864

(51) Int. Cl. G06Q 10/08

(52) U.S. Cl. CPC G06Q 10/08355; G01S 19/42; G06Q 10/0833

(57) ABSTRACT

An operation management apparatus manages an operation plan of a first transporter that transports articles and a second transporter that transports the articles transferred from the first transporter. The operation management apparatus includes: an information acquisition part that acquires first position information indicating a current position of the first transporter, second position information indicating a current position of the second transporter, and destination information indicating a delivery destination of the articles; and an operation management part that creates the operation plan by selecting a relay position to be used from among a plurality of relay positions where the articles transported by the first transporter can be transferred to the second transporter on the basis of the first position information, the second position information, and the destination information.

### CROSS-REFERENCE TO RELATED APPLICATIONS

The present application is a continuation application of International Application number PCT/JP2018/037008, filed on Oct. 3, 2018, which claims priority under 35 U.S.C § 119(a) to Japanese Patent Application No. 2017-225864, filed on Nov. 24, 2017. The entirety of each of the above-mentioned patent applications is hereby incorporated by reference herein and made a part of this specification.

### BACKGROUND

This disclosure relates to an apparatus, a system, and a method for managing operation of a plurality of types of transporters.

Conventionally, an operation management system that manages a route of a truck transporting goods is known. Japanese Unexamined Patent Application Publication No. 2014-149191 discloses an operation management system that can select an optimal route depending on loads.

Depending on destinations of goods, the need for using multiple types of transporters, such as a ship, an aircraft, and a land vehicle may arise. For example, the use of ships, aircrafts, and land vehicles in combination is conceivable when transporting goods to a house on a remote island. However, in the conventional technique which assumes using a single truck for transporting the goods, there was a problem that the optimal route is not selected if multiple types of transporters are used.

### SUMMARY

This disclosure focuses on this point, and an object of the present disclosure is to provide an operation management apparatus, an operation management system, and a method for managing operation that are capable of determining a route preferable in a case of transporting goods using multiple types of transporters.

An operation management apparatus according to a first aspect of the present disclosure manages an operation plan of a first transporter that transports articles and a second transporter that transports the articles transferred from the first transporter. The operation management apparatus includes: an information acquisition part that acquires first position information indicating a current position of the first transporter, second position information indicating a current position of the second transporter, and destination information indicating a delivery destination of the articles; and an operation management part that creates an operation plan by selecting a relay position to be used from among a plurality of relay positions where the articles transported by the first transporter can be transferred to the second transporter on the basis of the first position information, the second position information, and the destination information.

An operation management system according to a second aspect of the present disclosure includes: the first transporter that transports articles; the second transporter that transports the articles with a route different from a route of the first transporter; and an operation management apparatus that manages an operation plan of the first transporter and the second transporter, wherein the first transporter and the second transporter have a current position specification part that specifies a current position, and a notification part that gives the current position specified by the current position specification part to the operation management apparatus, and wherein the operation management apparatus has an information acquisition part that acquires first position information indicating a current position of the first transporter, second position information indicating a current position of the second transporter, and destination information indicating a delivery destination of the articles, and an operation management part that creates an operation plan by selecting a relay position to be used from among a plurality of relay positions where the articles transported by the first transporter can be transferred to the second transporter on the basis of the first position information, the second position information, and the destination information.

An operation managing method according to a third aspect of the present disclosure, is an operation managing method, performed by a computer, for managing an operation plan of the first transporter that transports articles and the second transporter that transports the articles transferred from the first transporter, and includes: an acquisition step of acquiring first position information indicating a current position of the first transporter, second position information indicating a current position of the second transporter, and destination information indicating a delivery destination of the articles; and a creating step of creating an operation plan by selecting a relay position to be used from among a plurality of relay positions where the articles transported by the first transporter can be transferred to the second transporter on the basis of the first position information, the second position information, and the destination information.

### BRIEF DESCRIPTION OF THE DRAWINGS

FIG. 1 illustrates an outline of an operation management system according to the present embodiment.

FIG. 2 shows a configuration of an operation management apparatus.

FIG. 3 shows an example of a transporter information table stored in a memory part.

FIG. 4 shows an example of a screen displayed on a display part.

FIG. 5 shows a second example of the screen displayed on the display part.

FIG. 6 is a flowchart showing an operation of selecting a transporter by the operation management apparatus.

FIG. 7 is a flowchart showing an operation of selecting a relay position by the operation management apparatus.

FIG. 8 is a flowchart showing an operation of determining a moving start time of a land transporter serving as a second transporter.

### DETAILED DESCRIPTION

Hereinafter, the present disclosure will be described through exemplary embodiments of the present disclosure, but the following exemplary embodiments do not limit the disclosure according to the claims, and not all of the combinations of features described in the exemplary embodiments are necessarily essential to the solution means of the disclosure.

### <Outline of an Operation Management System S>

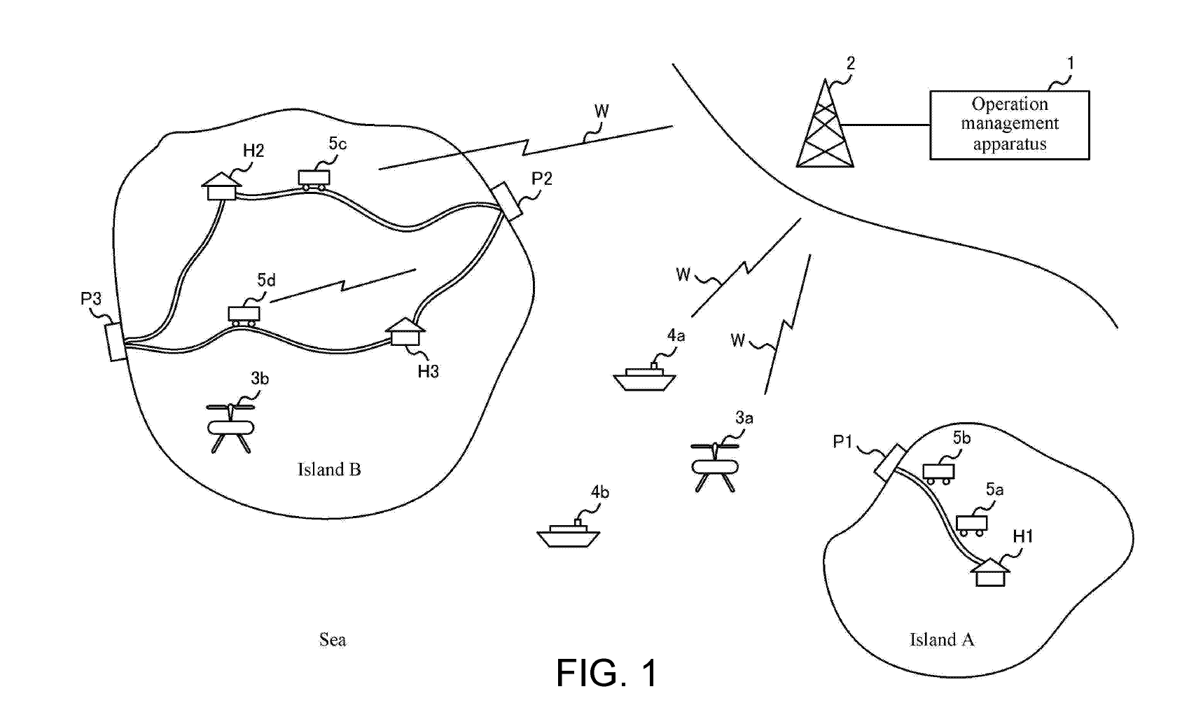

FIG. 1 illustrates an outline of an operation management system S according to the present embodiment. The operation management system S includes an operation management apparatus 1 and a plurality of transporters (a flying transporter 3, a water transporter 4, and a land transporter 5) that are communicatively connected with the operation management apparatus 1 via a base station 2. The operation management apparatus 1 manages the operation of the plurality of transporters. Specifically, the operation management apparatus 1 determines an operation plan, such as operation time and operation routes of the transporters transporting articles and gives the determined operation plan to each of the transporters.

In FIG. 1, as examples of the plurality of transporters, flying transporters 3 (3a, 3b), water transporters 4 (4a, 4b), and land transporters 5 (5a, 5b, 5c, 5d) are shown. The flying transporter 3 is a transporter capable of autonomously flying in air, for example, a drone or an unmanned small airplane. The water transporter 4 is a transporter capable of autonomously navigating over sea, for example, an unmanned boat or an unmanned ship. The land transporter 5 is a transporter capable of autonomously driving over land, for example, an unmanned car or an unmanned motorcycle. The flying transporter 3, the water transporter 4, and the land transporter 5 are connectable to a wireless communication line W and are capable of sending data to and receiving data from the operation management apparatus 1 via the base station 2 of a wireless communication network (i.e., a mobile phone network or a low power wide area (LPWA) network). It should be noted that a person may be on board the flying transporter 3, the water transporter 4, and the land transporter 5.

In the example shown in FIG. 1, it is presumed that articles from a hub H1 on an island A are to be transported to a hub H2 or a hub H3 on an island B. Because there is a sea between the islands A and B, it is not possible to transport the articles only by the land transporters 5. Also, because the water transporters 4 cannot travel over land, it is not possible to transport the articles just by the water transporters 4. Also, if a transport cost of the flying transporters 3 is high, transporting the articles all by the flying transporters 3 would result in an economic disadvantage. Therefore, it is necessary to transport the articles by combining any of the flying transporters 3, the water transporters 4, and the land transporters 5 depending on various conditions, such as size of articles, the number of articles, a location of a sender, a location of a delivery destination, weather, and delivery time slots.

When transporting the articles by combining any of the flying transporters 3, the water transporters 4, and the land transporters 5, a relay base at which a transfer of the articles is performed between the different transporters is required. On the island B of FIG. 1, ports P2 and P3 are established as the relay bases.

When transporting articles from the hub H1 on the island A to the hub H2 on the island B, many transport methods are conceivable by combining many transporters and many routes. For example, a transport method in which the articles are transported from the hub H1 to the port P2 by the flying transporter 3a, and then the land transporter 5c transports them from the port P2 to the hub H2 is conceivable. Also, another transport method in which the articles are transported from the hub H1 to the port P3 by the water transporter 4a, and then the land transporter 5d transports them from the port P3 to the hub H2 is conceivable. Still another transport method in which the articles are transported from the hub H1 to the hub H2 by the flying transporter 3b is conceivable. The operation management apparatus 1 has a unique feature of selecting an optimal transport method from among these transport methods in accordance with various conditions.

The operation management apparatus 1 determines, for example, whether to transfer the articles at the port P2 or at the port P3 depending on a position of each transporter, and transmits instructions to transporters to be used for the transportation so that the articles can be transported by the determined transport method. The operation management apparatus 1 displays, on a display, the position of the transporters to which the instructions were transmitted so that an operation manager can confirm whether the articles are being transported as planned.

As mentioned above, the operation management apparatus 1 manages the operation plan of (i) the first transporter that transports the articles and (ii) the flying transporter 3, the water transporter 4, and the land transporter 5, each serving as the second transporter that transports the articles delivered from the first transporter. A configuration and an operation of the operation management apparatus 1 will be explained in detail below.

### [Configuration of the Operation Management Apparatus 1]

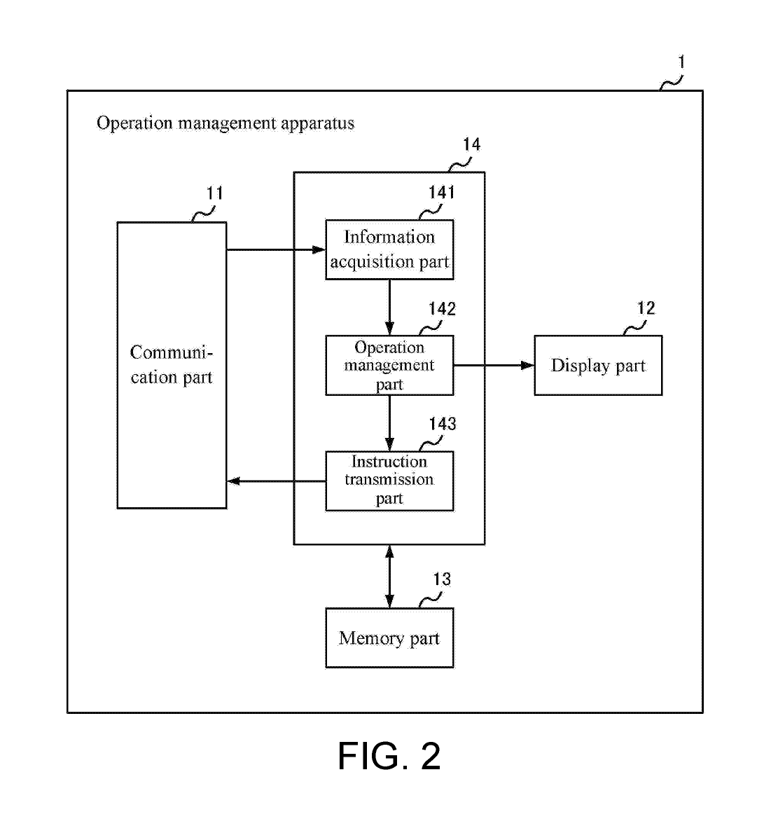

FIG. 2 shows a configuration of an operation management apparatus 1. The operation management apparatus 1 has a communication part 11, a display part 12, a memory part 13, and a control part 14. The communication part 11 has a communication interface for sending and receiving data among the flying transporter 3, the water transporter 4, and the land transporter 5 via the base station 2. The communication part 11 has a local area network (LAN) controller, for example.

The display part 12 is a display that displays various pieces of information. The display part 12 displays, for example, the positions of the flying transporter 3, the water transporter 4, and the land transporter 5 superimposed on a map image.

The memory part 13 is a storage medium, such as a read only memory (ROM) or a random access memory (RAM). The memory part 13 stores programs to be executed by the control part 14. Also, the memory part 13 stores operation plans of the flying transporter 3, the water transporter 4, and the land transporter 5. Also, the memory part 13 stores various pieces of information that would be needed when the control part 14 creates the operation plan.

The control part 14 is a central processing unit (CPU), for example. By executing the programs stored in the memory part 13, the control part 14 functions as an information acquisition part 141, an operation management part 142, and an instruction transmission part 143.

The information acquisition part 141 acquires various pieces of information that are used for creating the operation plan and for the operation manager to monitor operation status. The information acquisition part 141 acquires, for example, first position information indicating a current position of the first transporter, second position information indicating a current position of the second transporter, and destination information indicating a delivery destination of the articles. Each of the flying transporter 3, the water transporter 4, and the land transporter 5 identifies its latitude and longitude on the basis of radio waves received from a global positioning system (GPS) satellite and transmits position information indicating the identified latitude and longitude. The information acquisition part 141 acquires the position information received by the communication part 11 via the wireless communication line W and the base station 2. The information acquisition part 141 gives the acquired first position information and the acquired second position information to the operation management part 142. The operation management part 142 may also display the created operation plan on the display part 12.

Also, the information acquisition part 141 acquires destination information input in a computer (not shown) connected via a network, such as a LAN and the Internet. The computer is provided in, for example, a store of a courier that delivers the articles, accepts input of (i) sender information, such as an address of a sender of the articles to be delivered by the courier and (ii) destination information such as an address of the delivery destination, and transmits the accepted sender information and the destination information to the operation management apparatus 1. Upon receiving the sender information and the destination information from the computer, the information acquisition part 141 gives the received sender information and destination information to the operation management part 142.

Further, the information acquisition part 141 acquires weather information indicating weather conditions from meteorological observation apparatuses installed in various positions. The meteorological observation apparatuses measure weather information, such as temperature, wind direction, wind speed, and rainfall every five seconds, for example, and transmit the weather information to the operation management apparatus 1 at a predetermined time interval. The information acquisition part 141 acquires, for example, weather information around each of the transporters, weather information of the location of the sender, weather information of the location of the delivery destination, and weather information on various routes between the sender and the delivery destination. The information acquisition part 141 gives the acquired weather information to the operation management part 142.

The operation management part 142 creates the operation plan by selecting the transporters and selecting the relay positions on the basis of the various types of information acquired from the information acquisition part 141 and the various types of information stored in the memory part 13. Specifically, the operation management part 142 creates an operation plan that defines at which time and to where each of the flying transporter 3, the water transporter 4, and the land transporter 5 is to move, and then the operation management part 142 stores the created operation plan to the memory part 13 and gives the created operation plan to the instruction transmission part 143. Also, the operation management part 142, as will be described in detail below, may display the first position information and the second position information on the display part 12.

The instruction transmission part 143 transmits the operation plan given by the operation management part 142 to each of the flying transporter 3, the water transporter 4, and the land transporter 5 via the communication part 11. The instruction transmission part 143 giving the operation plan to the flying transporter 3, the water transporter 4, and the land transporter 5 in this manner enables the flying transporter 3, the water transporter 4, and the land transporter 5 to efficiently transport the articles based on the operation plan created by the operation management part 142. An operation of the operation management part 142 creating the operation plan will be explained in detail below.

### (Selecting the Transporters)

The operation management part 142 selects the first transporter and the second transporter from among the flying transporter 3, the water transporter 4, and the land transporter 5 based on at least any one of the location of the sender of the articles, the location of the delivery destination of the articles, and the relay position. The operation management part 142 selects, as the first transporter that receives the articles at the sender, a transporter nearest to the location of the sender (for example, a location of the hub H1) from among the flying transporter 3, the water transporter 4, and the land transporter 5 that can reach the location of the sender. In the example shown in FIG. 1, the operation management part 142 selects the land transporter 5a as the first transporter that receives the articles at the hub H1.

Also, the operation management part 142 selects, as the second transporter that receives the articles at the relay position, a transporter which is at the position nearest to the relay position that can be used for transporting the articles to the delivery destination from among the flying transporter 3, the water transporter 4, and the land transporter 5 that can reach the delivery destination. In the example shown in FIG. 1, the operation management part 142 selects the land transporter 5c as the second transporter that receives the articles at the port P2 and selects the land transporter 5d as the second transporter that receives the articles at the port P3. In this manner, the operation management part 142 selects the transporters based on the locations of the sender and the delivery destination of the articles, the relay position, and the like. Consequently, delivery time of the articles and transportation cost can be reduced.

The number of articles that are transportable, transport speed, transportable distance, and transportation cost differ for each transporter. For this reason, the operation management part 142 may select the first transporter and the second transporter based on at least any one of the number, type, delivery deadline, distance to the delivery destination, and allowable cost of the articles to be delivered. When selecting the first and the second transporters to be used, the operation management part 142 references a transporter information table stored in the memory part 13.

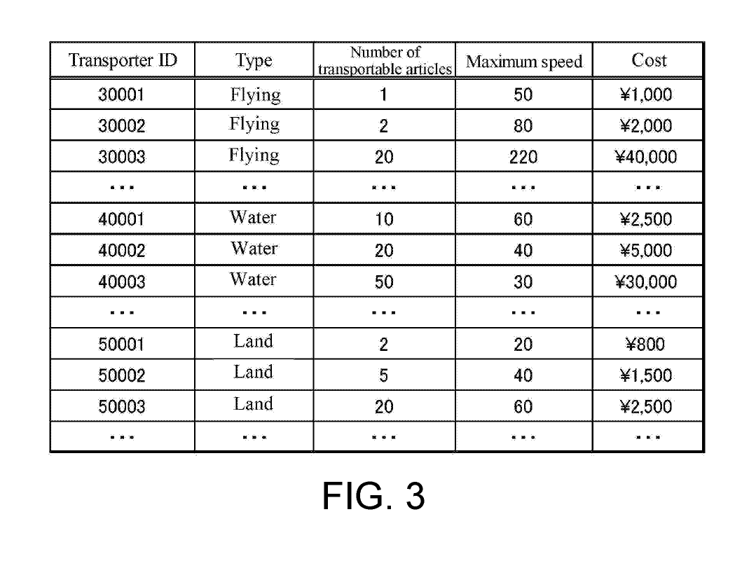

FIG. 3 shows an example of the transporter information table stored in the memory part 13. In the table relevant to transporter information, a transporter identification (ID) which is identification information of a transporter, a type of a transporter, the number of transportable articles, a maximum speed, and a transport cost are associated with each other. The number of transportable articles corresponds to the number of articles, within a reference size (for example, a cube with sides of 50 cm) that can be delivered at a time. The cost corresponds to a charge amount per hour.

The operation management part 142 selects a transporter which is capable of delivering more articles than the number of articles to be delivered. For example, if 5 units of articles need to be delivered, the operation management part 142 selects the flying transporter 3 whose transporter ID is 30003, instead of the flying transporter 3 whose transporter ID is 30002. If the size of articles that must be transported is larger than the size that can be transported by the flying transporter 3, the operation management part 142 selects the water transporter 4 or the land transporter 5, instead of the flying transporter 3.

Also, the operation management part 142 selects a transporter based on the maximum speed when there is no leeway in meeting the delivery deadline. In the example shown in FIG. 3, the operation management part 142 selects the flying transporter 3 whose transporter ID is 30003 as the transporter to be used for delivering the articles with no leeway in meeting the delivery deadline. Meanwhile, the operation management part 142 selects the flying transporter 3 whose transporter ID is 30001 or the land transporter 5 whose transporter ID is 50001 when there is time until the delivery deadline and priority needs to be given to lower cost.

The operation management part 142 may select a transporter based on traffic condition information indicating traffic conditions on the route where the second transporter moves from a plurality of candidates of relay positions to the delivery destination. The traffic condition information is, for example, information about whether or not there is any road construction, and traffic jam information. For example, if a road between the port P2 and the hub H2 is being shut down, the operation management part 142 creates an operation plan in which the articles are transported from the port P2 to the hub H2 by the flying transporter 3b instead of the land transporter 5c. The operation management part 142 may create an operation plan in which the flying transporter 3a flies from the port P1 directly to the hub H2, without changing the transporters at the port P2.

The operation management part 142 may select a transporter based on topographic information indicating landforms on the route where the second transporter moves from the plurality of candidates of relay positions to the delivery destination. The topographic information is, for example, information indicating a multitude of hills, information indicating whether there is a mountainous area, and the like. For example, if an area between the port P2 and the hub H2 is mountainous and unsuitable for the land transporter 5c to travel, the operation management part 142 creates an operation plan in which the articles are transported from the port P2 to the hub H2 by the flying transporter 3b instead of the land transporter 5c.

### (Selecting the Relay Position)

The operation management part 142 creates the operation plan by selecting a relay position in use (hereinafter referred to as a relay position to be used) from among the plurality of relay positions where the articles transported by the first transporter can be transferred to the second transporter on the basis of the first position information indicating the position of the first transporter, the second position information indicating the position of the second transporter, and the destination information. In the example shown in FIG. 1 the relay positions are the port P2 and the port P3.

Here, suppose that the sender is located at the hub H1 and the delivery destination is the hub H2. Suppose that the operation management part 142 searched for transporters that can be used to transport the articles from the port P1 to the hub H2 and has identified that the flying transporter 3a and the land transporter 5c can be used. In this case, the operation management part 142 determines at which one of the relay positions, out of the port P2 and the port P3, the flying transporter 3a and the land transporter 5c transfer the articles, on the basis of information (the first position information) indicating the current position of the flying transporter 3a and information (the second position information) indicating the current position of the land transporter 5c.

### (Selecting of the Relay Position to be Used on the Basis of Weather Information)

The operation management part 142 utilizes various pieces of information for selecting the relay position to be used. The operation management part 142 selects, for example, a relay position to be used on the basis of the first weather information, acquired by the information acquisition part 141, indicating weather conditions on a plurality of routes by which the first transporter can move to each of the relay positions. Specifically, the operation management part 142 selects the port P3 as the relay position to be used if (i) a headwind is blowing in a direction from the port P2 to the port P1 on the route the flying transporter 3a flies from the port P1 to the port P2 and (ii) a tailwind is blowing in a direction from the port P1 to the port P3 on the route the flying transporter 3a flies from the port P1 to the port P3.

The operation management part 142 may select the relay position to be used also on the basis of the second weather information, acquired by the information acquisition part 141, indicating weather conditions on a plurality of routes where the second transporter moves from each of the relay positions to the delivery destination. The operation management part 142 selects, for example, the port P2 as the relay position to be used if (i) there is no heavy rain on the route between the port P2 and the hub H1 and (ii) there is heavy rain on the route between the port P3 and the hub H1.

If the result of selecting the relay position to be used on the basis of the first weather information and the result of selecting the relay position to be used on the basis of the second weather information do not match, the operation management part 142 selects a relay position to be used so that the transporter would not pass through the route with worse weather conditions. The operation management part 142 may give priority to the selection result which is based on the weather conditions on the route of a transporter more likely to be affected by the weather conditions out of the first transporter and the second transporter. The operation management part 142 selects, for example, the port P3 as the relay position to be used by giving priority to the selection result based on the first weather information on the route of the flying transporter 3a which is more likely to be affected by the weather conditions than the land transporter 5c. In this way, the operation management part 142 can create a safe operation plan.

### (Selecting the Relay Position to be Used on the Basis of Traffic Condition Information)

The operation management part 142 may select the relay position to be used on the basis of the traffic condition information, acquired by the information acquisition part 141, indicating traffic conditions on the plurality of routes where the second transporter moves from each of the relay positions to the delivery destination. In the example shown in FIG. 1, the operation management part 142 selects the port P3 as the relay position to be used if a road is under construction or traffic is heavy in between the port P2 and the hub H2. However, giving priority to safety, the operation management part 142 may select the port P2 as the relay position to be used even if the road is under construction or the traffic is heavy in between the port P2 and the hub H2 when the route between the port P2 and the hub H2 is not impassable and the weather conditions on the routes between the port P3 and the hub H2 are bad.

### (Selecting the Relay Position to be Used on the Basis of Topographic Information)

The operation management part 142 may select the relay position to be used on the basis of the topographic information, acquired by the information acquisition part 141, indicating landforms on the routes where the second transporter moves from the plurality of relay positions to the delivery destination. The operation management part 142 selects the port P3 as the relay position to be used, for example, if a range from the port P2 to the hub H2 is a mountainous area, and therefore fuel efficiency of the land transporter 5c is anticipated to be poor.

### (Determining a Necessity of Relay)

The operation management part 142 may determine whether or not to transfer the articles at the relay position on the basis of at least any one of the location of the sender of the articles, the location of the delivery destination of the articles, the number of articles, the type of articles, a delivery deadline, and the allowable cost of the articles. The operation management part 142 determines, for example, to transfer the articles between the flying transporter 3 and the land transporter 5 or between the water transporter 4 and the land transporter 5 at the relay position if there is a sea between the locations of the sender and the delivery destination. Also, the operation management part 142 may determine to transfer the articles at the relay position if a distance between the locations of the sender and the delivery destination is longer than a movable distance of the flying transporter 3, the water transporter 4, or the land transporter 5.

Also, the operation management part 142 determines to transfer the articles at the relay position located in between many senders and one delivery destination if there is need to transport the articles from many senders to one delivery destination. At that time, the operation management part 142 selects, as the transporter to be used for transporting the articles from the relay position to the delivery destination, a transporter capable of transporting more articles than the transporter to be used for transporting the articles from many senders to the relay position.

Also, if there is no leeway in meeting the delivery deadline and yet there is a wide margin in the allowable cost, the operation management part 142 sets two relay positions between the sender and the delivery destination and determines to use the flying transporter 3 whose transporter ID is ID30003 which can fly across the section between the two relay positions at high speed. In this way, a transport time from the sender to the delivery destination can be reduced because the articles can be transported across a section between the two relay positions at high speed even if the flying transporter 3, which is capable of flying at high speed, needs a wide space for take-off and landing and is incapable of reaching the sender and the delivery destination.

### (Determining a Timing to Start Moving)

When setting the relay position between the sender and the delivery destination, it is desirable to have the second transporter arrive at the relay position prior to the arrival of the first transporter to the relay position in order to minimize a time required to transfer the articles from the first transporter, which has arrived at the relay position, to the second transporter. Thus, the operation management part 142 creates an operation plan for the first transporter and the second transporter so that the second transporter reaches the relay position before the first transporter reaches the relay position on the basis of (i) a relationship between a distance from the current position (for example, the position of the hub H1) of the first transporter to the relay position and a moving speed of the first transporter and (ii) a relationship between a distance from the current position of the second transporter to the relay position and a moving speed of the second transporter.

To create the above-mentioned operation plan, the operation management part 142 first calculates a time required for the first transporter to reach the relay position on the basis of the relationship between the distance from the current position of the first transporter to the relay position and the moving speed of the first transporter. The operation management part 142 calculates an estimated time for the first transporter to reach the relay position by adding a calculated time to the time at which a first transporter is scheduled to leave its current position.

Next, the operation management part 142 calculates a time required for the second transporter to reach the relay position on the basis of the relationship between the distance from the current position of the second transporter to the relay position and the moving speed of the second transporter. The operation management part 142 determines a time at which the second transporter must leave its current position by subtracting a calculated time from the estimated time at which the first transporter reaches the relay position.

The operation management part 142 may have the second transporter leave at a time that is earlier, by a predetermined time margin, than the determined time in case of the first transporter reaching the relay position earlier than what was assumed to be the estimated time or in case of the second transporter taking more time than what was assumed to be the time required for the second transporter to reach the relay position. The operation management part 142, for example, increases a time margin if the weather conditions on the route on which the first transporter moves are good and decreases the time margin if the weather conditions on the route on which the first transporter moves are bad. In this way, the operation management part 142 can transfer the articles to the second transporter without having the first transporter wait, even if the first transporter reaches the relay position earlier under good weather conditions.

The operation management part 142 may have at least one second transporter out of the plurality of the second transporters reach the relay position before the first transporter reaches the relay position on the basis of a plurality of pieces of second position information acquired by the information acquisition part 141. In the example shown in FIG. 1, out of the land transporters 5c and 5d, both of which may serve as the second transporters, the operation management part 142 determines a departure time of the land transporter 5c so that the land transporter 5c reaches the port P2 before the flying transporter 3a that flies from the port P1 reaches the port P2. Here, the land transporter 5c is assumed to reach the port P2 ahead of the land transporter 5d, and the port P2 is used as the relay position. In this way, the operation management part 142 can more reliably have the second transporter reach the relay position before the first transporter reaches the relay position.

### (Determining the Route to the Relay Position)

There is a case where the sender of the articles exists on the route of the second transporter moving to the relay position in order to receive the articles from the first transporter. For example, suppose that there is a need to deliver an article A sent out from the hub H1 to the hub H2 and to deliver another article B from the hub H3 to the hub H1, as the example shown in FIG. 1. In such a case, having to move the land transporter 5c to the port P2 to receive the article A and move the land transporter 5d to the port P2 to send the article B is inefficient.

Therefore, the operation management part 142 may create an operation plan in which the second transporter reaches the relay position on the basis of passing point information, acquired by the information acquisition part 141, indicating a location of a point that the second transporter passes before moving to the relay position. As in the example shown in FIG. 1, when acquiring the passing point information indicating that the hub H3 is the passing point from the information acquisition part 141, the operation management part 142 creates an operation plan in which (i) the land transporter 5d moves to the port P2 after the land transporter 5d stops by at the hub H3 to receive the article B, and (ii) the land transporter 5d having loaded the article A received from the flying transporter 3a at the port P2 moves from the port P2 to the hub H2.

According to this operation plan, after having unloaded the article B at the port P2, the land transporter 5d can receive the article A from the flying transporter 3a and transport the received article A to the hub H2. Also, after unloading the article A, the flying transporter 3a, which transported the article A, can receive the article B and transport the article B to the hub H1. In this way, a time period during which the transporters move without carrying the articles can be reduced, and therefore the efficiency of transport improves.

### (Prevention of Collisions)

The operation management part 142 creates the operation plan taking into consideration a prevention of collisions between the transporters. On the basis of automatic dependent surveillance (ADS) information transmitted from a manned aircraft and automatic identification system (AIS) information transmitted from a manned ship, the operation management part 142 creates, for example, an operation plan in which the flying transporter 3 does not fly in a region within a predetermined distance from the aircraft and the ship, the ADS information and the AIS information being acquired by the information acquisition part 141. Specifically, if the first transporter or the second transporter is the flying transporter 3, the operation management part 142 creates an operation plan so that a flying route of the flying transporter 3 is separated from the ship by a predetermined distance or more. The operation management part 142, for example, prevents the flying transporter 3 from flying over a region within a predetermined range from the position where the ship is sailing. In this way, it is possible to prevent the flying transporter 3 from colliding with another aircraft or a ship.

### (Displaying a Position of Each Transporter)

As mentioned above, the display part 12 displays positions of the flying transporter 3, the water transporter 4, and the land transporter 5 superimposed on the map image on the basis of the pieces of position information of the flying transporter 3, the water transporter 4 and the land transporter 5, acquired from the information acquisition part 141. The display part 12 may display scheduled positions of the flying transporter 3, the water transporter 4, and the land transporter 5 at a time specified by a user (for example, an operation manager of a courier) based on the operation plan acquired from the operation management plan 142. The display part 12 may simultaneously display (i) the scheduled positions of the flying transporter 3, the water transporter 4, and the land transporter 5 at the specified time and (ii) their current positions.

What the user wants to confirm changes depending on the whereabouts of the articles whose transport state is of his/her interest. For example, if the first transporter transporting the articles is flying, sailing, or running smoothly, the user is inclined to give priority to comprehensively grasping the transport state of other articles as well. Meanwhile, if the first transporter approaches the relay position where the transfer of the articles takes place, the user is inclined to confirm whether or not the second transporter, which is on the receiving side of the articles, has arrived at the relay position.

For this reason, the operation management part 142 may change a scale of displaying the current positions of the first transporter and the second transporter on the display part 12 depending on the current position of the first transporter transporting the articles. The operation management part 142 may enlarge and display a region around the first transporter or a region around the relay position, for example, on the condition that the current position of the first transporter is within a predetermined distance from the relay position. The predetermined distance is, for example, a distance from (i) a position where the first transporter must reach by an estimated time when the second transporter, which receives the articles from the first transporter, reaches the relay position to (ii) the relay position. After the second transporter reaches the relay position, the operation management part 142 may enlarge and display an image such that the relay position and the first transporter are included in the image.

Also, the operation management part 142 may change a display mode of an area around the current position of the first transporter depending on the current position of the first transporter transporting the articles. The operation management part 142 may display in detail an area around the current position of the second transporter that receives the articles, for example, at a time the first transporter transporting the articles arrived within a predetermined range of the relay position. The operation management part 142 may display a building, a landform, a name of place, and the like in the nearby regions of the second transporter and the relay position, for example, at the time the first transporter arrived within the predetermined range of the relay position. This makes it easier for the user to take an appropriate countermeasure in such a case where the second transporter has not reached the relay position, because the user can confirm situations near the relay position in detail at a time the first transporter approached closer to the relay position.

Also, if trouble, an error, or the like occurs in any of the transporters, the operation management part 142 may enlarge and display the region around the transporter with the trouble, error, or the like. This makes it easier for the user to take countermeasures such as to look for a place to withdraw the transporter having the trouble, error, or the like.

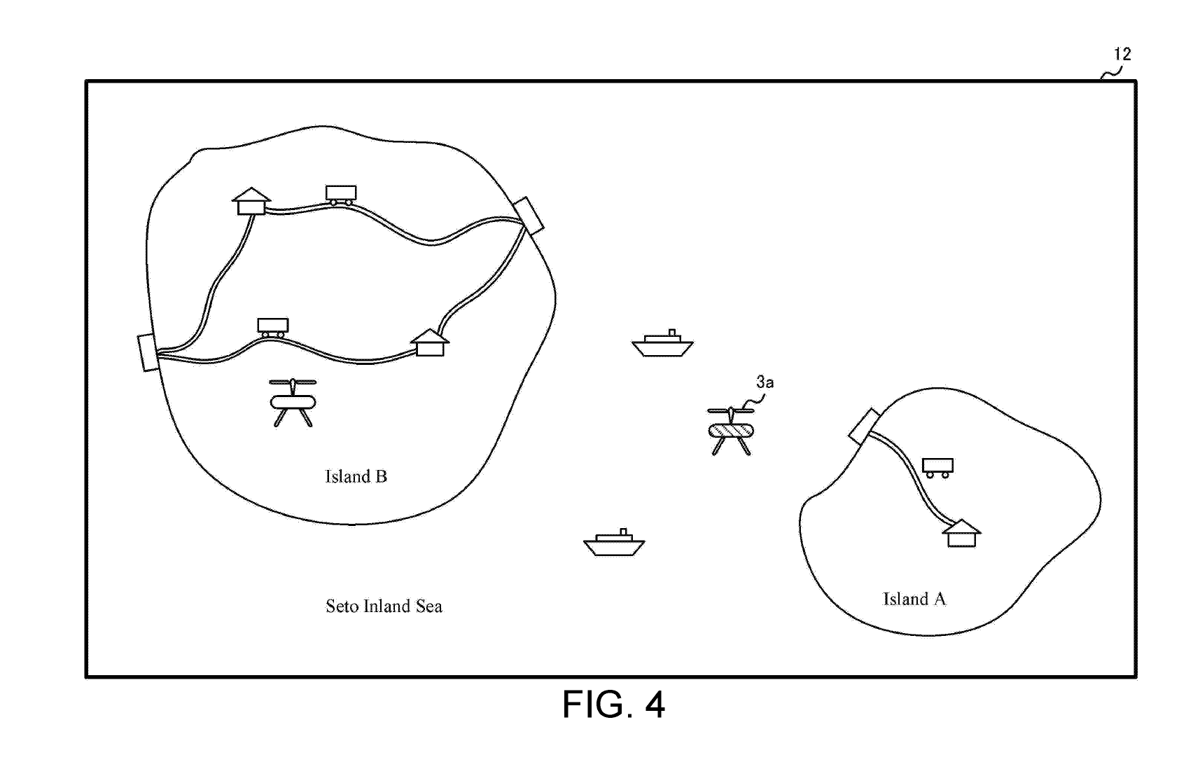

FIG. 4 shows an example of a screen displayed on the display part 12. FIG. 4 is a screen on which the flying transporter 3a, selected as the first transporter by the user, is displayed in a state of being separated by a predetermined distance or more from the port P2 where the articles are scheduled to be transferred. In FIG. 4, all of the flying transporters 3, the water transporters 4, and the land transporters 5 shown in FIG. 1 are displayed together with the map images of the island A, the island B, and the like.

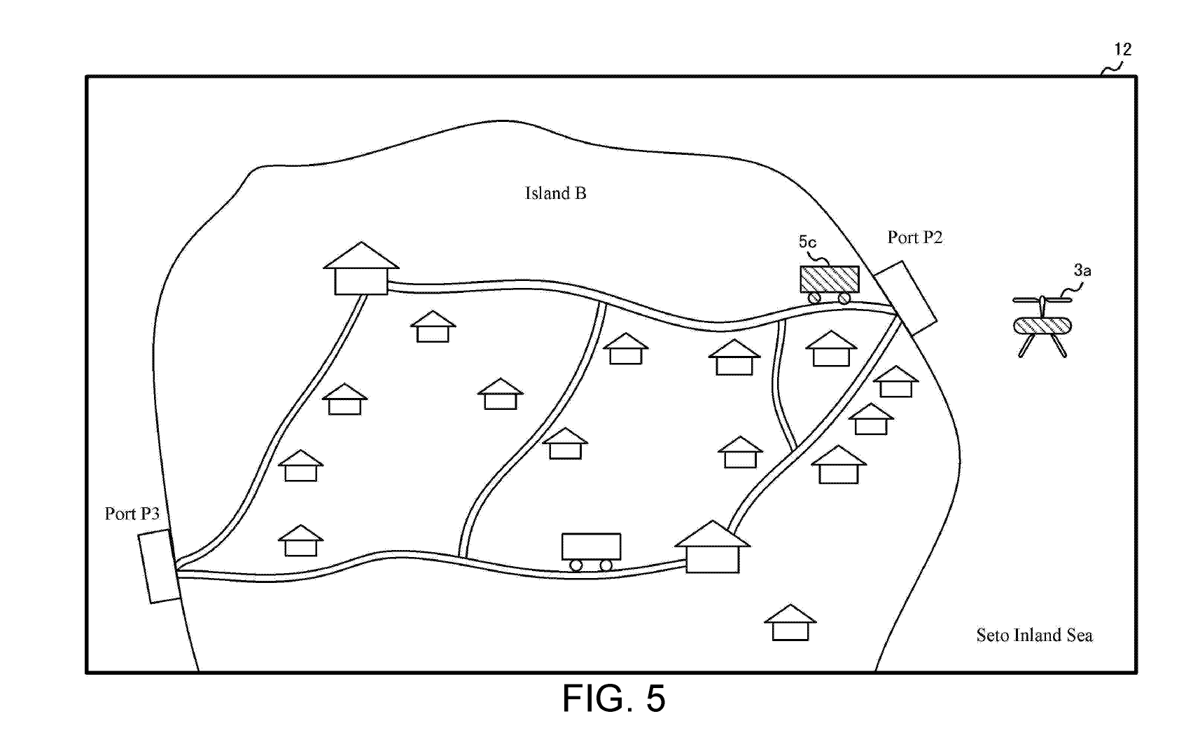

FIG. 5 shows a second example of the screen displayed on the display part 12. FIG. 5 is a screen on which the flying transporter 3a, selected by the user, is displayed in a state of being less than the predetermined distance from the port P2 where the articles are scheduled to be transferred, and the surroundings of the flying transporter 3a are enlarged and displayed. Also, in FIG. 5, the flying transporter 3a, selected by the user, and the land transporter 5c, serving as the second transporter that receives the articles from the flying transporters 3a, are highlighted. By looking at the screen enlarged in this manner, the user can confirm that the land transporter 5c scheduled to receive the articles has arrived near the port P2.

If the land transporter 5c has not arrived near the port P2, the user can confirm where the land transporter 5c is by displaying a wider range by performing an operation of changing the scale of the display. The user may run a search by inputting a transporter ID of the land transporter 5c and display a range that includes the land transporter 5c.

It should be noted that, in the above explanation, cases where the display part 12 displays the positions of the flying transporter 3, the water transporter 4, and the land transporter 5 have been given, but the information acquisition part 141 and the operation management part 142 may transmit the position information and the operation plan to an external display via the communication part 11 and display the scheduled positions and the current positions of the flying transporter 3, the water transporter 4, and the land transporter 5.

### [Flowchart of an Operation of Selecting a Transporter by the Operation Management Apparatus 1]

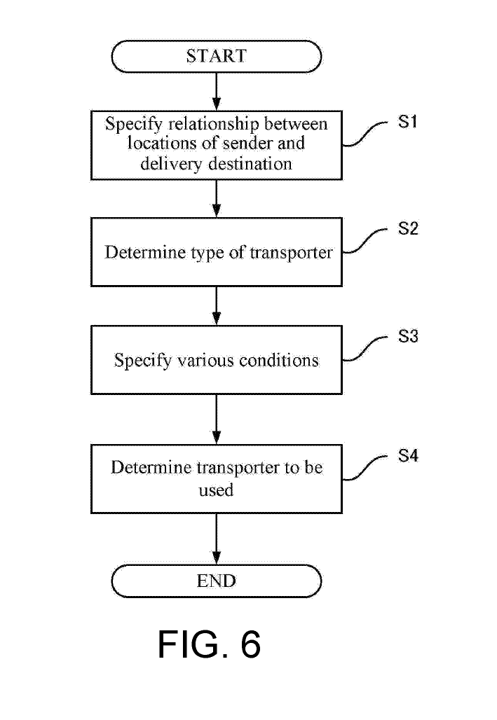

FIG. 6 is a flowchart showing an operation of selecting a transporter by the operation management apparatus 1. The process in the flowchart shown in FIG. 6 starts when the user who manages the operation plan using the operation management apparatus 1 performs the operation of selecting the transporter for transporting the articles.

First, the operation management part 142 specifies a relationship between the locations of the sender and the delivery destination on the basis of the sender information and the destination information acquired by the information acquisition part 141 (S1). Then, the operation management part 142 determines the type of transporter to be used on the basis of the relationship between the locations of the sender and the delivery destination (S2). The operation management part 142 selects, for example, the flying transporter 3 or the water transporter 4 if there is a sea between the locations of the sender and the delivery destination, and selects the flying transporter 3 or the land transporter 5 if there is no sea between the locations of the sender and the delivery.

Next, the operation management part 142 specifies various conditions (for example, the number, the type, the delivery deadline, the distance to the delivery destination, and the allowable cost of the articles) required for transporting (S3). Next, by referencing pieces of information relevant to the transporters such as the information contained in the transporter information table shown in FIG. 3, the operation management part 142 selects, from among the transporters whose type was determined in step S2, a transporter that suits the conditions for transporting (S4).

### [Flowchart of an Operation of Selecting a Relay Position by the Operation Management Apparatus 1]

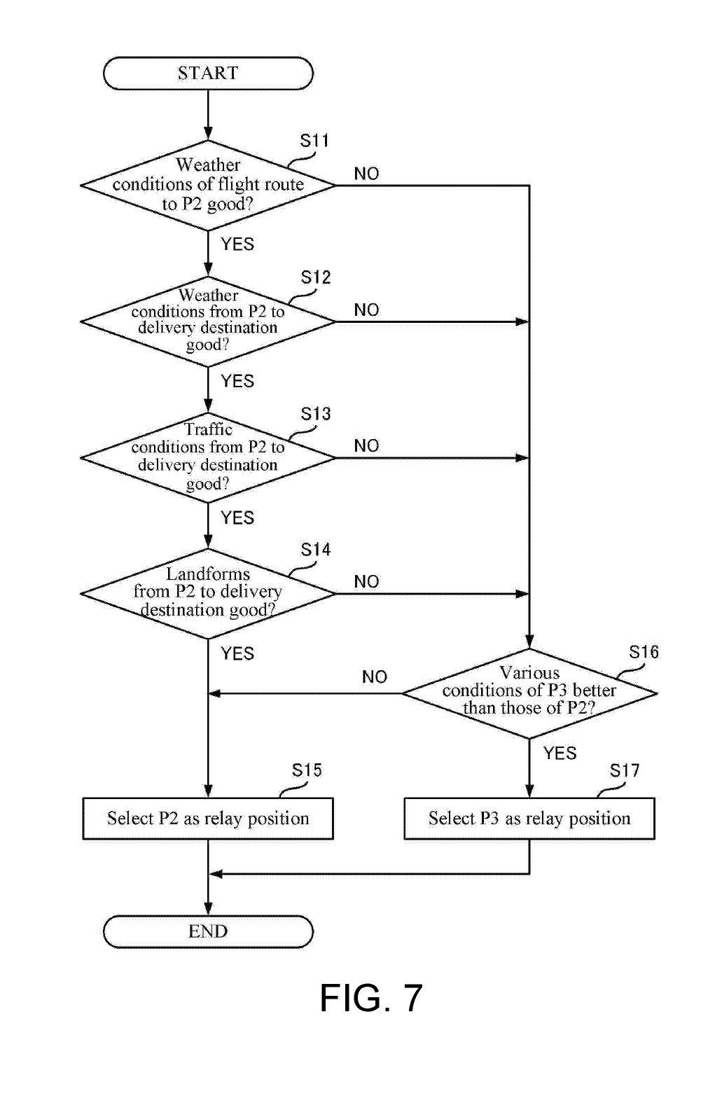

FIG. 7 is a flowchart showing an operation of selecting a relay position by the operation management apparatus 1. The process in the flowchart shown in FIG. 7 starts when the user who manages the operation plan using the operation management apparatus 1 performs the operation of selecting the relay position that will be a destination where the flying transporter 3a that transports the articles flies. The operation management apparatus 1 may start the operation shown in FIG. 7 when the transporters are determined with the procedure shown in FIG. 6.

First, the operation management part 142 determines whether weather conditions of a flight route between a departure point of the flying transporter 3a and the port P2 are good or not on the basis of the weather information acquired from the information acquisition part 141 (S11). If the operation management part 142 determines that the weather conditions of the flying route are good (YES in S11), it determines whether weather conditions around a road from the port P2 to the delivery destination are good or not (S12).

Next, if the operation management part 142 determines that the weather conditions around the road from the port P2 to the delivery destination are good (YES in S12), it determines whether traffic conditions of the road from the port P2 to the delivery destination are good or not (S13). If the operation management part 142 determines that the traffic conditions are good (YES in S13), it determines whether landforms from the port P2 to the delivery destination are suitable for the land transporter 5c to travel (S14). If the operation management part 142 determines that the landforms are good (YES in S14), it determines the port P2 as the relay position (S15).

Meanwhile, if any one of the determination results of S11 to S14 is NO, the operation management part 142 performs determinations similar to that of S11 to S14 for the port P3 (S16). If the operation management part 142 determines that the determination results for the port P3 are better than those of the port P2 (YES in S16), it selects the port P3 as the relay position (S17). If the operation management part 142 determines that the determination results for the port P3 are worse than those of the port P2 (NO in S16), it selects the port P2 as the relay position.

When making the determination in step S16, the operation management part 142 compares the port P2 with the port P3 by, for example, comparing the number of YES's determined in each determination of S11 to S14. The operation management part 142 may calculate evaluation points by weighting a coefficient which is determined for each determination item and compare the port P2 with the port P3 by comparing their evaluation points. If the evaluation points of the port P2 and those of the port P3 are the same, the operation management part 142 may display a piece of information to that effect on the display part 12 to notify the user.

It should be noted that the operation management part 142 may select the relay position in accordance with conditions other than the determination conditions mentioned above. The operation management part 142 may select a relay position, for example, based on whether or not the relay position is suitable for the transporters capable of being used.

### [Flowchart of an Operation of Determining a Moving Start Time of the Second Transporter]

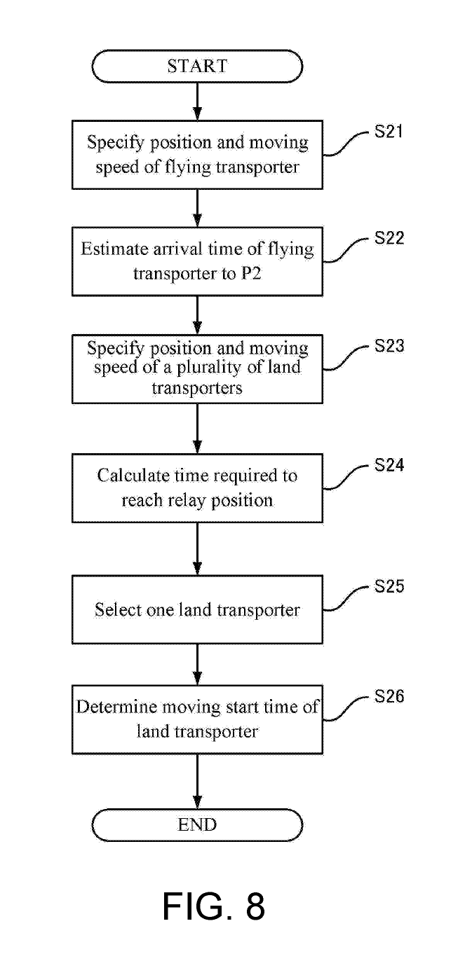

FIG. 8 is a flowchart showing an operation of determining a start time when the land transporter 5c serving as the second transporter starts to move. The process in the flowchart shown in FIG. 8 starts when the user performs the operation of determining the moving start time of the second transporter.

First, the operation management part 142 specifies, on the basis of the position information acquired from the information acquisition part 141, a current position of the flying transporter 3a, serving as the first transporter from which the second transporter receives the articles. Also, by referencing the transporter information table stored in the memory part 13, the operation management part 142 specifies the moving speed of a flying transporter 3a (S21). The operation management part 142 may specify the moving speed of the flying transporter 3a on the basis of an amount of change in position per unit time indicated by the position information acquired from the information acquisition part 141. On the basis of (i) a distance between a specified current position of the flying transporter 3a and the relay position, and (ii) a specified moving speed of the flying transporter 3a, the operation management part 142 estimates a time that the flying transporter 3a reaches the relay position (S22).

Next, the operation management part 142 specifies a current position and a moving speed of a plurality of the land transporters 5 that are capable of coming to the relay position (S23). On the basis of the moving speed and a specified distance between the current position and the relay position, the operation management part 142 calculates a time required for each of the land transporters 5 to reach the relay position (S24). The operation management part 142 selects, as the second transporter, the land transporter 5 that is estimated to reach the relay position first (S25).

Suppose that the operation management part 142 has selected the land transporter 5c. When selecting the land transporter 5c as the second transporter, the operation management part 142 determines, on the basis of a required time calculated in S24 and a time estimated for the land transporter to reach the relay position in S22, the start time when the land transporter 5c starts so that the land transporter 5c can reach the relay position before the flying transporter 3a (S26).

### [Effects of the Operation Management Apparatus 1 According to the Present Embodiment]

As explained above, the operation management part 142 creates the operation plan by selecting the relay position to be used from among the plurality of relay positions on the basis of the information indicating (i) the position of the first transporter that transports the articles, (ii) the position of the second transporter that receives the articles from the first transporter, and (iii) the delivery destination. In this way, the operation management apparatus 1 can determine the preferred route in the case of transporting the articles using multiple types of transporters.

Also, the operation management part 142 selects the relay position to be used based further on the first weather information indicating weather conditions on the routes between the position of the first transporter and the plurality of the relay positions or the second weather information indicating weather conditions on the routes between the position of the second transporter and the plurality of the relay positions. In this way, the operation management apparatus 1 can create the operation plan with a low probability of a delay or an accident that would occur due to an influence of the weather.

Also, the operation management part 142 selects the relay position on the basis of the traffic conditions and landforms on the route from the relay position to the delivery destination. In this way, it is possible to create the operation plan with a low probability of the second transporter being delayed due to an influence of road construction, a heavy traffic jam, or landforms.

Also, the operation management part 142 creates the operation plan of the first and the second transporters so that the second transporter reaches the relay position before the first transporter reaches the relay position. In this way, the delivery time of the articles can be reduced because the articles can be quickly transferred to the second transporter at a time the first transporter reaches the relay position.

Also, the operation management part 142 changes the display mode of the area around the current position of the first transporter depending on the current position of the first transporter. For example, the operation management part 142 displays in detail the area around the current position of the first transporter at a time the first transporter arrived within the predetermined range from the relay position. This makes it easier for the user to take an appropriate countermeasure in such a case where the second transporter has not reached the relay position, because the user can confirm situations near the relay position in detail by the time the first transporter approaches closer to the relay position.

The present disclosure is explained on the basis of the exemplary embodiments. The technical scope of the present disclosure is not limited to the scope explained in the above embodiments and it is possible to make various changes and modifications within the scope of the disclosure. For example, the specific embodiments of the distribution and integration of the apparatus are not limited to the above embodiments, all or part thereof, can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

What is claimed is:

1. An operation management apparatus for managing an operation plan of a first transporter that transports articles and a second transporter that transports the articles transferred from the first transporter, the operation management apparatus comprising:
an information acquisition part that acquires first position information indicating a current position of the first transporter, second position information indicating a current position of the second transporter, and destination information indicating a delivery destination of the articles; and
an operation management part that creates the operation plan by selecting a relay position to be used from among a plurality of relay positions where the articles transported by the first transporter can be transferred to the second transporter, on the basis of the first position information, the second position information, and the destination information.

2. The operation management apparatus according to claim 1, wherein the information acquisition part further acquires first weather information indicating weather conditions on a plurality of routes by which the first transporter can move to each of the relay positions, and
the operation management part selects the relay position to be used further on the basis of the first weather information.

3. The operation management apparatus according to claim 1, wherein the information acquisition part further acquires second weather information indicating weather conditions on a plurality of routes where the second transporter moves from each of the relay positions to the delivery destination, and
the operation management part selects the relay position to be used further on the basis of the second weather information.

4. The operation management apparatus according to claim 1, wherein the information acquisition part further acquires traffic condition information indicating traffic conditions on a plurality of routes where the second transporter moves from each of the relay positions to the delivery destination, and
the operation management part selects the relay position to be used further on the basis of the traffic condition information.

5. The operation management apparatus according to claim 1, wherein the information acquisition part further acquires topographic information indicating landforms of a plurality of routes where the second transporter moves from each of the relay positions to the delivery destination, and
the operation management part selects the relay position to be used further on the basis of the topographic information.

6. The operation management apparatus according to claim 1, wherein the operation management part selects the first transporter and the second transporter from among a flying transporter, a water transporter, and a land transporter based on at least any one of a location of a sender of the articles, a location of the delivery destination, and the number of the articles.

7. The operation management apparatus according to claim 1, wherein the operation management part determines whether or not to transfer the articles at the relay position based on at least any one of a location of a sender of the articles, a location of the delivery destination, and the number of the articles.

8. The operation management apparatus according to claim 1, wherein the operation management part creates the operation plan for the first transporter and the second transporter so that the second transporter reaches the relay position before the first transporter reaches the relay position on the basis of (i) a relationship between a distance from the current position of the first transporter to the relay position and a moving speed of the first transporter and (ii) a relationship between a distance from the current position of the second transporter to the relay position and a moving speed of the second transporter.

9. The operation management apparatus according to claim 8, wherein the information acquisition part acquires a plurality of pieces of the second position information corresponding to a plurality of the second transporters, and
the operation management part makes at least one second transporter out of the plurality of the second transporters reach the relay position before the first transporter reaches the relay positions on the basis of the plurality of the pieces of the second position information.

10. The operation management apparatus according to claim 1, wherein the information acquisition part further acquires passing point information indicating a location of a point that the second transporter passes before moving to the relay position, and
the operation management part creates the operation plan for a period before the second transporter reaches the relay position on the basis of the passing point information, acquired by the information acquisition part.

11. The operation management apparatus according to claim 1, wherein the first transporter or the second transporter is a flying transporter,
the information acquisition part further acquires a piece of information indicating a current position of a ship that moves over sea, and
the operation management part creates the operation plan so that a flying route of the flying transporter is separated from the ship by a predetermined distance or more.

12. The operation management apparatus according to claim 1, wherein the operation management part changes a scale of displaying current positions of the first transporter and the second transporter on a display part depending on the current position of the first transporter transporting the articles.

13. The operation management apparatus according to claim 12, wherein the operation management part changes a display mode of an area around the current position of the first transporter depending on the current position of the first transporter.

14. The operation management apparatus according to claim 13, wherein the operation management part displays in detail the area around the current position of the first transporter at a time that the first transporter arrived within a predetermined range of the relay position.

15. An operation management system comprising:
a first transporter that transports articles;
a second transporter that transports the articles with a route different from a route of the first transporter; and
an operation management apparatus that manages an operation plan of the first transporter and the second transporter, wherein the first transporter and the second transporter have:
a current position specification part that specifies a current position, and
a notification part that gives the current position specified by the current position specification part to the operation management apparatus, and wherein the operation management apparatus has:
an information acquisition part that acquires first position information indicating a current position of the first transporter, second position information indicating a current position of the second transporter, and destination information indicating a delivery destination of the articles, and
an operation management part that creates the operation plan by selecting a relay position to be used from among a plurality of relay positions where the articles transported by the first transporter can be transferred to the second transporter on the basis of the first position information, the second position information, and the destination information.

16. An operation managing method, performed by a computer, for managing an operation plan of a first transporter that transports articles and a second transporter that transports the articles transferred from the first transporter, the operation managing method comprising:
an acquisition step of acquiring first position information indicating a current position of the first transporter, second position information indicating a current position of the second transporter, and destination information indicating a delivery destination of the articles; and
a creating step of creating the operation plan by selecting a relay position to be used from among a plurality of relay positions where the articles transported by the first transporter can be transferred to the second transporter on the basis of the first position information, the second position information, and the destination information.
